(19) United States
(12) Patent Application Publication
(10) Pub. No.: US 2025/0024035 A1
(43) Pub. Date: Jan. 16, 2025

(54) IMAGE COMPRESSION DEVICE AND IMAGE COMPRESSION METHOD

(71) Applicant: Sumitomo Electric Industries, Ltd., Osaka-shi, Osaka (JP)

(72) Inventors: Li YUE, Osaka-shi, Osaka (JP); Naoki MAEDA, Osaka-shi, Osaka (JP); Shigeharu TOYODA, Osaka-shi, Osaka (JP); Tsuyoshi HAGA, Osaka-shi, Osaka (JP); Tomoyuki KITADA, Osaka-shi, Osaka (JP); Takeshi HACHIKAWA, Osaka-shi, Osaka (JP); Hidenori YAMAMOTO, Osaka-shi, Osaka (JP)

(73) Assignee: Sumitomo Electric Industries, Ltd., Osaka-shi, Osaka (JP)

(21) Appl. No.: 18/714,589

(22) PCT Filed: Jul. 13, 2023
(86) PCT No.: PCT/JP2023/025908

§ 371 Date: May 30, 2024

(30) Foreign Application Priority Data
Oct. 27, 2022 (JP) 2022-171929

(51) Int. Cl. H04N 19/119; H04N 19/136; H04N 19/176

(52) U.S. Cl. CPC H04N 19/119; H04N 19/136; H04N 19/176

(57) ABSTRACT

An image compression device includes an extraction unit configured to extract a protection target region from an image, the protection target region being a region including a protection target of personal information; and a compression unit configured to compress the image by compressing the protection target region at a compression ratio higher than a compression ratio for a region other than the protection target region in the image.

### TECHNICAL FIELD

The present disclosure relates to an image compression device and an image compression method. This application claims priority based on Japanese Patent Application No. 2022-171929 filed on Oct. 27, 2022, and the entire contents of the Japanese patent application are incorporated herein by reference.

### BACKGROUND ART

The use of video images captured by various cameras such as an on-vehicle camera mounted on an automobile, a camera mounted on a mobile robot, and a monitoring camera installed in a factory or on a road, etc., is spreading.

For example, these video images are expected to be used for map production, road maintenance, area marketing, monitoring of production lines, and the like.

On the other hand, there is a possibility that personal information such as a human face, a house name plate, an inside of a house, or a license plate of an automobile is included in the video images. Each country has an agreement on how to handle such personal information. For example, in the European Union (EU), it is considered as a protection target in the General Data Protection Regulation (GDPR).

Artificial intelligence (AI) is used to remove the protection target from the video images (see, for example, Non-patent literature 1 and Non-patent literature 2).

The conventional AI detects a region of a face or a license plate, which requires protection of personal information, from the video images, and performs mosaic process on the detected region or replaces the face or the license plate with a face or a license plate generated by the Al, thereby removing the personal information from the video images.

### CITATION LIST

### Non Patent Literature

NPL 1: “Masking-AI”, [online], 2021, TRUST SMITH Co., Ltd., [retrieved on Aug. 8, 2022]. Internet <URL: https://www.trustsmith.net/masking-ai/>
NPL 2: “brighter AI”, [online], MACNICA HOLDINGS, INC., [retrieved on August 8, 2022], Internet <URL: https://www.macnica.co.jp/business/dx/manufacturers/brighterai/>

### SUMMARY OF INVENTION

An image compression device according to an aspect of the present disclosure includes an extraction unit configured to extract a protection target region from an image. the protection target region being a region including a protection target of personal information; and a compression unit configured to compress the image by compressing the protection target region at a compression ratio higher than a compression ratio for a region other than the protection target region in the image.

The present disclosure can be implemented as an image compression method including characteristic processes executed by the image compression device as steps. In addition, the present disclosure can also be implemented as a computer program for causing a computer to function as a characteristic processing unit included in the image compression device, or a computer program for causing a computer to execute characteristic steps included in the image compression method. It is needless to say that the computer program can be distributed via a computer-readable non-transitory recording medium such as a compact disc-read only memory (CD-ROM) or a communication network such as the Internet. The present disclosure can also be implemented as a semiconductor integrated circuit that implements a part or all of the image compression device, or as an image processing system including the image compression device.

### BRIEF DESCRIPTION OF THE DRAWINGS

FIG. 1 is a diagram showing an example of an overall configuration of an image processing system according to a first embodiment.

FIG. 2 is a diagram showing an example of an image output by a camera.

FIG. 3 is a block diagram showing an example of a configuration of an image compression device according to a first embodiment.

FIG. 4 is a diagram showing the image shown in FIG. 2 divided into a plurality of blocks.

FIG. 5 is a diagram showing an example of a protection target region in an image.

FIG. 6 is a diagram showing an example of a result of extraction of a protection target region by a protection target region extraction unit.

FIG. 7 is a block diagram showing an example of a configuration of a server according to a first embodiment.

FIG. 8 is a flowchart showing an example of a procedure of processing executed by a camera and an image compression device.

FIG. 9 is a flowchart showing an example of a procedure of processing executed by a server.

FIG. 10 is a block diagram showing an example of a configuration of an image compression device according to a second embodiment.

FIG. 11 is a flowchart showing an example of a procedure of processing executed by a camera and an image compression device.

FIG. 12 is a diagram showing an example of a result of extraction of a protection target region and a protection target size by a protection target region extraction unit.

FIG. 13 is a flowchart showing an example of a procedure of processing executed by a camera and an image compression device.

FIG. 14 is a flowchart showing an example of a procedure of processing executed by a camera and an image compression device.

FIG. 15 is a block diagram showing an example of a configuration of a server according to a fifth embodiment.

FIG. 16 is a flowchart showing an example of a procedure of processing executed by a server.

### DETAILED DESCRIPTION

### Problems to be Solved by Present Disclosure

According to the conventional AI, although the personal information can be removed, there is a problem that data amount of the video image is large because the video image is not compressed.

The present disclosure has been made in view of the above problems, and an object of the present disclosure is to provide an image compression device and an image compression method capable of removing personal information while reducing data amount of the image.

### Advantageous Effects of Present Disclosure

According to the present disclosure, the personal information can be removed while reducing the data amount of the image.

### Overview of Embodiments of Present Disclosure

First, an overview of embodiments of the present disclosure will be listed and described. (1) An image compression device according to an embodiment of the present disclosure includes an extraction unit configured to extract a protection target region from an image, the protection target region being a region including a protection target of personal information; and a compression unit configured to compress the image by compressing the protection target region at a compression ratio higher than a compression ratio for a region other than the protection target region in the image.

For example, the compression unit compresses the protection target region at a high compression ratio at which personal information such as a face or a license plate cannot be recognized even when the compressed protection target region is decompressed. Thus, the compression of the image and removal of the personal information can be performed simultaneously. That is, the personal information can be removed while reducing the data amount of the image.

(2) In the above (1), the extraction unit may be configured to extract the protection target region by determining whether each of a plurality of blocks obtained by dividing the image corresponds to the protection target region.

By determining whether it corresponds to the protection target region in units of blocks, a determination process of the protection target region can be efficiently performed. In addition, since the image can be compressed in units of blocks, the image can be efficiently compressed and the personal information can be efficiently removed.

(3) In the above (1) or (2), the image compression device may further include a masking processing unit configured to perform a masking process of removing the personal information from the protection target region. The compression unit may be configured to compress the image that has been subjected to the masking process.

For example, when a size of the protection target such as a face or a license plate included in the protection target region is large, there is a possibility that the personal information is read from a decompressed image, but by performing the masking process, the data amount of the image can be reduced after the personal information is reliably removed. Note that, the size of the protection target does not mean an actual size of the protection target (actual size in a three dimensional space), but means a size in the image. For example, the size of the protection target means the number of pixels occupied by the protection target region in the image.

(4) In the above (3), the masking processing unit may be configured to perform, based on a size of the protection target included in the protection target region, the masking process on the protection target region.

For example, the masking process is executed when the size of the protection target such as a face or a license plate included in the protection target region is equal to or larger than a predetermined value, and the masking process is not executed in other cases. This makes it possible to remove the personal information while preventing the masking process from being unnecessarily executed and reducing the data amount of the image.

(5) In any one of the above (1) to (4), the compression unit may be configured to determine, based on a size of the protection target included in the protection target region, a compression ratio at which the protection target region is to be compressed.

For example, the compression ratio can be increased as the size of the protection target such as a face or a license plate included in the protection target region is increased. This makes it possible to reduce the data amount of the image while reliably removing the personal information.

(6) In the above (4) or (5), the size of the protection target may be determined based on an area of the protection target included in the protection target region and an area of each of blocks obtained by dividing the image.

For example, the masking process is executed when the area of the protection target is large compared to the area of the block, and the masking process is not executed in other cases. This makes it possible to remove the personal information while preventing the masking process from being unnecessarily executed and reducing the data amount of the image

(7) In any one of the above (1) to (6), the image compression device may further include an output unit configured to output position information of the protection target region in the image.

For example, a server that has acquired the compressed image and the position information of the protection target region can decompress the image while changing the compression ratio based on the position information. In addition, when the masking process is not performed, the server may perform the masking process on the protection target region based on the position information. This allows the server to execute other image processing after reliably removing the personal information.

(8) An image compression method according to another embodiment of the present disclosure includes extracting a protection target region from an image, the protection target region being a region including a protection target of personal information; and compressing the image by compressing the protection target region at a compression ratio higher than a compression ratio for a region other than the protection target region in the image.

This configuration includes the characteristic processes in the above-described image compression device as steps. Thus, the same operations and effects as the above-described image compression device are achieved.

### Details of Embodiments of Present Disclosure

Embodiments of the present disclosure will now be described with reference to the drawings. It should be noted that each of the embodiments described below represents a specific example of the present disclosure. Numerical values, shapes, materials, constituent elements, arrangement positions and connection forms of constituent elements. steps, order of steps, and the like shown in the following embodiments are examples and do not limit the present disclosure. In addition, among the constituent elements in the following embodiments, constituent elements not recited in the independent claims are constituent elements that can be arbitrarily added. In addition, each drawing is a schematic diagram and is not necessarily strictly illustrated.

The same constituent elements are denoted by the same reference numerals. Since their functions and names are the same, their descriptions are omitted as appropriate.

### First Embodiment

### [Overall Configuration of Image Processing System]

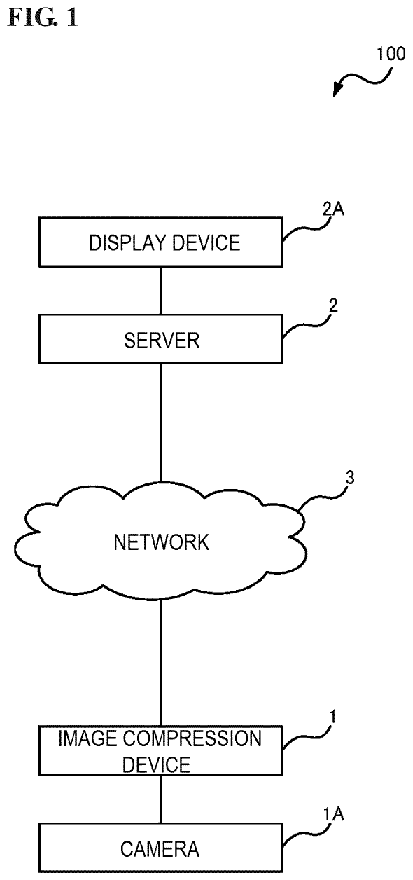

FIG. 1 is a diagram illustrating an example of an overall configuration of an image processing system according to a first embodiment. An image processing system 100 includes an image compression device 1 and a server 2 which are connected to each other via a network 3 such as the Internet, a camera 1A connected to image compression device 1, and a display device 2A connected to server 2. Image compression device 1 and server 2 are connected to network 3 in a wired or wireless manner.

Camera 1A is, for example, an on-vehicle camera mounted on an automobile. However, camera 1A is not limited to the in-vehicle camera. For example, camera 1A may be a camera mounted on a mobile robot, a monitoring camera attached to a facility of a factory, or an infrastructure camera installed on a roadside to monitor traffic flow.

Camera 1A captures a subject and outputs an image of the subject. The image may be a time-series image, that is, a video image. Camera 1A may be provided inside image compression device 1 and included in a constituent element of image compression device 1.

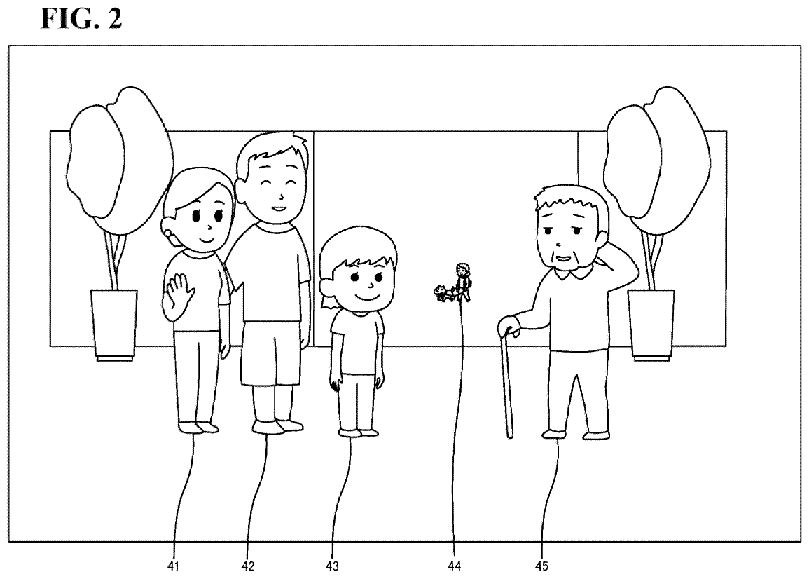

FIG. 2 is a diagram showing an example of an image output by camera 1A. In the image shown in FIG. 2, a person 41, a person 42, a person 43, and a person 44 are shown. Image compression device 1 compresses the image captured by camera 1A and transmits the compressed image to server 2.

Server 2 receives the compressed image from image compression device 1 via network 3, and decompresses the received compressed image. Server 2 performs a predetermined image processing on the decompressed image. For example, server 2 detects a position of an object included in the image, a region circumscribing the object, and the like by the image processing.

Display device 2A is configured by a liquid crystal display, an organic electroluminescence (EL) display, or the like, and displays the image after decompression by server 2, a result of the image processing by server 2, or the like.

### [Configuration of Image Compression Device 1]

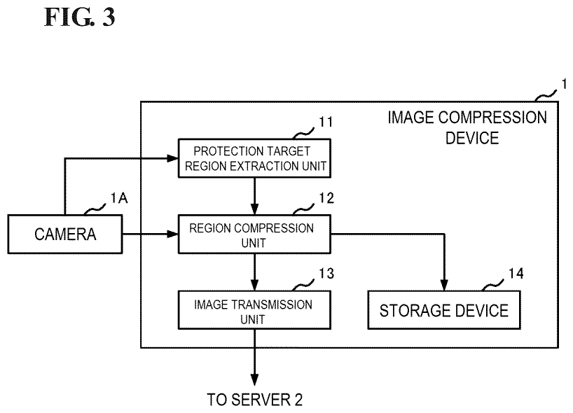

FIG. 3 is a block diagram showing an example of a configuration of image compression device 1 according to the first embodiment. Image compression device 1 is connected to camera 1A, and includes a protection target region extraction unit 11, a region compression unit 12, an image transmission unit 13, and a storage device 14.

Image compression device 1 may be configured by a computer system including a processor such as a central processing unit (CPU) and storage device 14 such as a volatile memory or a non-volatile memory. Each of processing units 11, 12, and 13 exerts its function by executing computer programs stored in storage device 14 on the processor.

Protection target region extraction unit 11 receives, from camera 1A, the image captured by camera 1A. Protection target region extraction unit 11 extracts a protection target region, which is a region including a protection target of personal information, from the received image.

For example, when a unit for determining whether or not the image includes the protection target is a block, protection target region extraction unit 11 divides the image into a plurality of blocks and determines, for each of the blocks, whether or not a predetermined protection target is included. Thus, region compression unit 12, which will be described later, extracts the protection target region to be compressed at a higher compression ratio than the region other than the protection target region in the image.

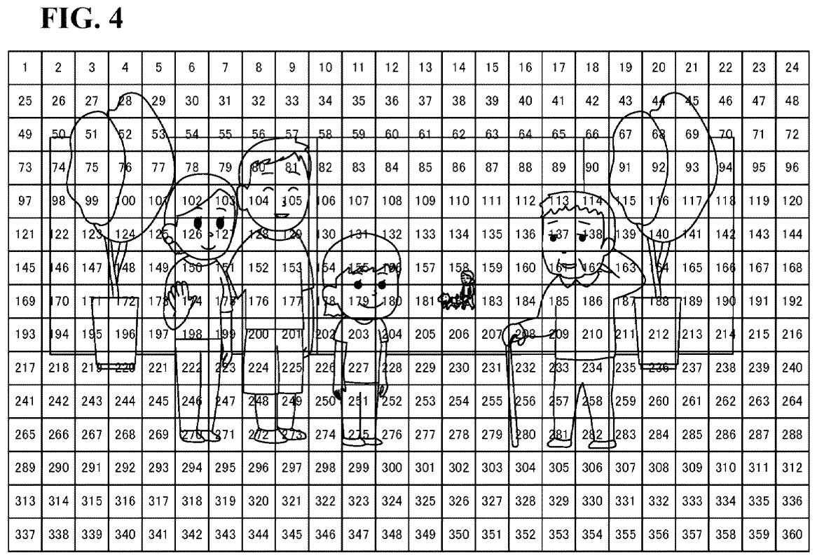

The processing of protection target region extraction unit 11 will be described in detail below. FIG. 4 is a diagram showing the image shown in FIG. 2 divided into a plurality of blocks. Here, an example is shown in which one image is divided into 360 blocks of 15 rows×24 columns. As shown in FIG. 4, block numbers from 1 to 360 are assigned to respective blocks in the raster scanning order from the upper left to the lower right of the image. However, the size and the number of blocks are not limited to those shown in FIG. 4. The protection target to be determined by protection target region extraction unit 11 is, for example, a human face. However, the protection target is not limited to the human face, and may be a license plate of an automobile or the like.

Protection target region extraction unit 11 determines whether or not a human face is included in each of the blocks from block number 1 to block number 360 using a learning model. The learning model is, for example, a convolution neural network (CNN), a recurrent neural network (RNN), or an AutoEncoder. Learning of human faces is advanced by a machine learning method such as deep learning using images of blocks including various human faces (hereinafter referred to as “block images”) as teacher data, and parameters of the learning model are determined.

Specifically, protection target region extraction unit 11 inputs the image including 360 block images to the learning model. The learning model determines whether or not the protection target is included in each block and outputs a determination result. Protection target region extraction unit 11 obtains the determination result from the learning model.

Protection target region extraction unit 11 determines the block including the protection target as the protection target region to be compressed at a compression ratio higher than a compression ratio for other blocks.

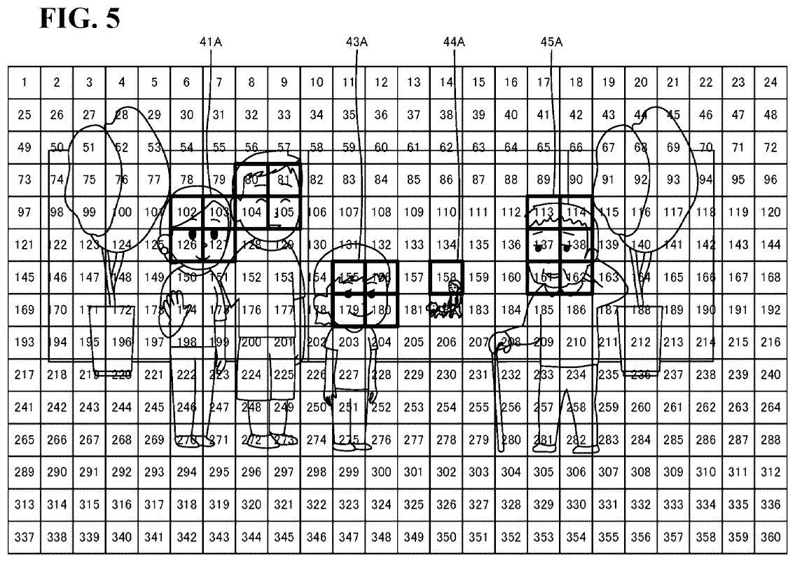

FIG. 5 is a diagram showing an example of a protection target region in an image. Protection target region extraction unit 11 extracts the protection target region from the image shown in FIG. 2 by classifying blocks including a protection target adjacent to each other in four or eight neighborhoods into the same protection target region. Thus, protection target regions 41A, 43A, 44A, and 45A are extracted. Protection target region 41A is constituted by a thick-framed block including a face of person 41 and a thick-framed block including a face of person 42. Protection target region 43A, protection target region 44A, and protection target region 45A are constituted by the thick-framed blocks including a face of person 43, a face of person 44, and a face of a person 45, respectively.

Protection target region 41A is a region including the 80th, 81st, 102nd to 105th, 126th, and 127th blocks. Protection target region 43A is a region including the 155th, 156th, 179th, and 180th blocks. Protection target region 44A is a region including the 158th block. Protection target region 45A is a region including the 113th, 114th, 137th, 138th, 161st, and 162nd blocks.

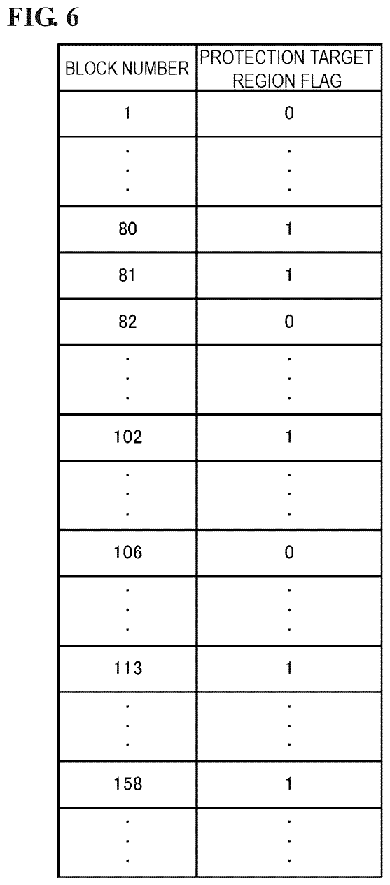

FIG. 6 is a diagram showing an example of a result of extraction of the protection target region by protection target region extraction unit 11. A table shown in FIG. 6 shows whether or not the protection target is included for each block number. That is, a block including the protection target is indicated by “1”, and a block not including the protection target is indicated by “0”. For example, it is indicated that the first block does not include the protection target. It is indicated that the 80th block includes the protection target.

Referring again to FIG. 3, protection target region extraction unit 11 outputs the result of extraction of the protection target region to region compression unit 12.

Region compression unit 12 receives the image captured by camera 1A from camera 1A and compresses the image. More specifically, region compression unit 12 compresses the image by compressing the protection target region extracted by protection target region extraction unit 11 at a compression ratio higher than a compression ratio for a region other than the protection target region in the image.

The compression method is, for example, H.264/MPEG-4 AVC or H.265/MPEG-H HEVC. As the compression ratio is increased, the quality of the decompressed image (region) is reduced.

In the above-described example, region compression unit 12 compresses the block images included in protection target regions 41A, 43A, 44A, and 45A at a relatively higher compression ratio than the other block images (for example, the block image of the first block), and compresses the other block images at a relatively lower compression ratio. Here, it is desirable that the compression ratio when compressing the block image included in the protection target region is determined in advance to be a compression ratio at which personal information such as a face or a license plate cannot be recognized even when the protection target region is decompressed.

Region compression unit 12 adds position information of the protection target region in the image to the compressed image. An example of the position information is a result of extraction shown in FIG. 6.

Region compression unit 12 writes the compressed image to which the position information of the protection target region is added to storage device 14. Region compression unit 12 outputs the compressed image to which the position information of the protection target region is added to image transmission unit 13.

Image transmission unit 13 transmits the compressed image to which the position information of the protection target region acquired from region compression unit 12 is added to server 2 via network 3.

### [Configuration of Server 2]

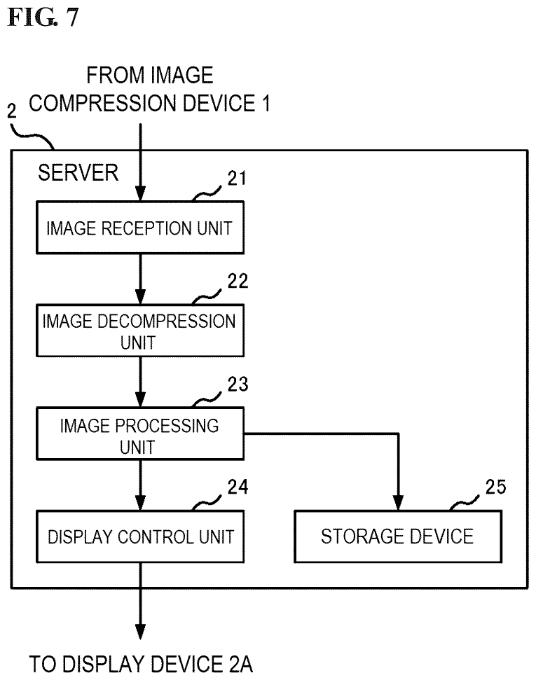

FIG. 7 is a block diagram showing an example of a configuration of server 2 according to the first embodiment. Server 2 includes an image reception unit 21, an image decompression unit 22, an image processing unit 23, a display control unit 24, and a storage device 25.

Server 2 may be configured by a computer system including a processor such as a CPU and storage device 25 such as a volatile memory or a non-volatile memory. Each of processing units 21, 22, 23, and 24 exerts its function by executing computer programs stored in storage device 25 on the processor.

Image reception unit 21 receives, from image compression device 1 via network 3, the compressed image to which the position information of the protection target region is added, and outputs the compressed image to image decompression unit 22.

Image decompression unit 22 decompresses the compressed image received by image reception unit 21 to restore the original image, and outputs the restored image to image processing unit 23. Specifically, image decompression unit 22 refers to the position information of the protection target region, and decompresses the block image included in the protection target region by a decompression method corresponding to the compression method performed on the block image included in the protection target region. Image decompression unit 22 refers to the position information and decompresses the block image not included in the protection target region by the decompression method corresponding to the compression method performed on the block image not included in the protection target region. In the example shown in FIG. 5, even when the block images included in protection target regions 41A, 43A, 44A, and 45A are decompressed and restored, a person or a computer cannot recognize the personal information such as a face.

Image processing unit 23 performs the predetermined image processing on the decompressed image. For example, image processing unit 23 detects a circumscribed rectangle region of the object included in the image. Image processing unit 23 may execute a region division process for extracting the region of the object included in the image in units of pixels. Further, image processing unit 23 may execute a skeleton estimation process for estimating a skeleton of the object included in the image.

Image processing unit 23 outputs a result of the image processing to display control unit 24. Image processing unit 23 writes the result of the image processing in storage device 25. Display control unit 24 displays the result of the image processing acquired from image processing unit 23 on display device 2A.

### [Processing Procedure of Image Compression Device 1]

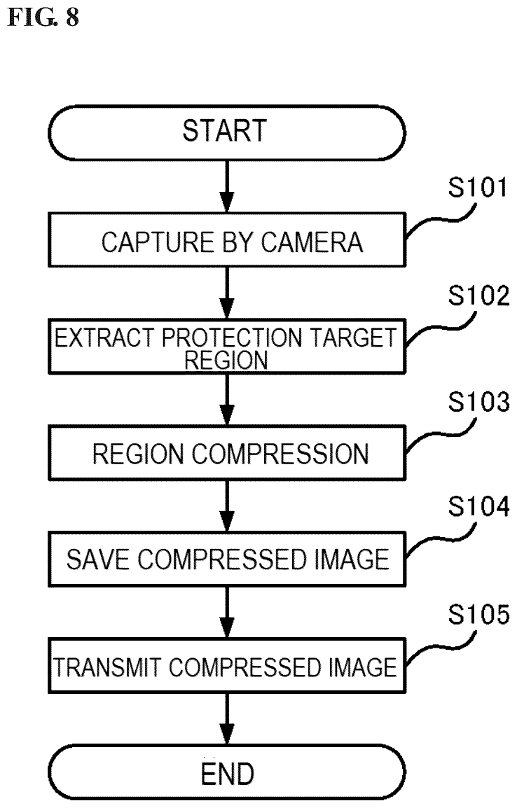

FIG. 8 is a flowchart showing an example of a procedure of processing executed by camera 1A and image compression device 1. Camera 1A generates an image by capturing an image of a subject (step S101). As a result, the image as shown in FIG. 2 is obtained, for example.

Protection target region extraction unit 11 extracts the protection target region, which is the region including the protection target of the personal information, from the image captured by camera 1A (step S102). For example, protection target regions 41A. 43A, 44A, and 45A as shown in FIG. 4 are extracted.

Region compression unit 12 sets, to the protection target region extracted by protection target region extraction unit 11, a compression ratio higher than a compression ratio for the region other than the protection target region in the image, and compresses the image at the set compression ratio (step S103).

Region compression unit 12 adds position information of the protection target region extracted in the processing of step S102 to the compressed image generated in the processing of step S103, and writes the compressed image to storage device 14 (step S104).

Image transmission unit 13 acquires the compressed image to which the position information of the protection target region is added from region compression unit 12, and transmits the compressed image to server 2 (step S105).

### [Processing Procedure of Server 2]

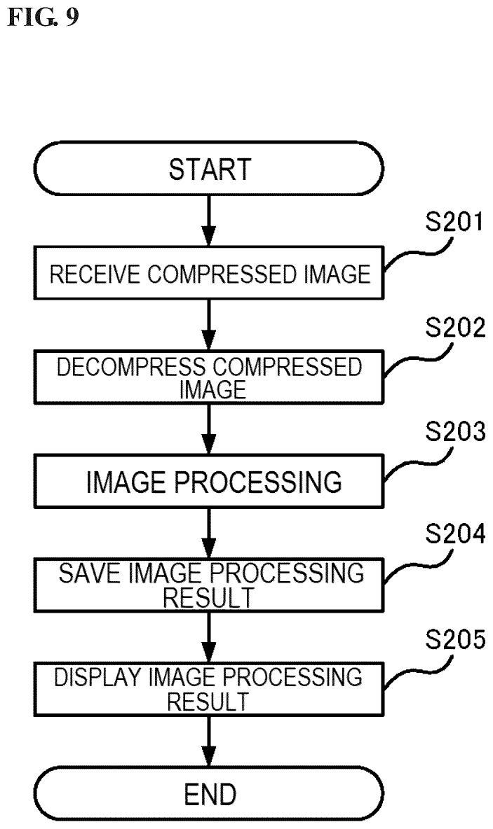

FIG. 9 is a flowchart showing an example of a procedure of processing executed by server 2. Image reception unit 21 receives the compressed image to which the position information of the protection target region is added from image compression device 1 via network 3 (step S201)

Image decompression unit 22 decompresses the compressed image received by image reception unit 21 to restore the original image (step S202).

Image processing unit 23 performs the predetermined image processing on the decompressed image (step S203).

Image processing unit 23 writes a result of the image processing in storage device 25 (step S204).

Display control unit 24 acquires the result of the image processing from image processing unit 23 and displays the result on display device 2A (step S205).

According to the first embodiment, image compression device 1 compresses the protection target region at a high compression ratio at which personal information such as a face or a license plate cannot be recognized even when the compressed protection target region is decompressed. Thus, the compression of the image and the removal of the personal information can be performed simultaneously. That is, the personal information can be removed while reducing the data amount of the image.

Further, image compression device 1 can efficiently perform the determination process of the protection target region by determining, in units of blocks, whether or not the block corresponds to the protection target region. In addition, image compression device 1 can compress the image in units of blocks, and thus can efficiently compress the image and remove the personal information.

### Second Embodiment

In the second embodiment, an example in which a masking process is further performed on the protection target region will be described. The configurations of image processing system 100 and server 2 are the similar to those in the first embodiment.

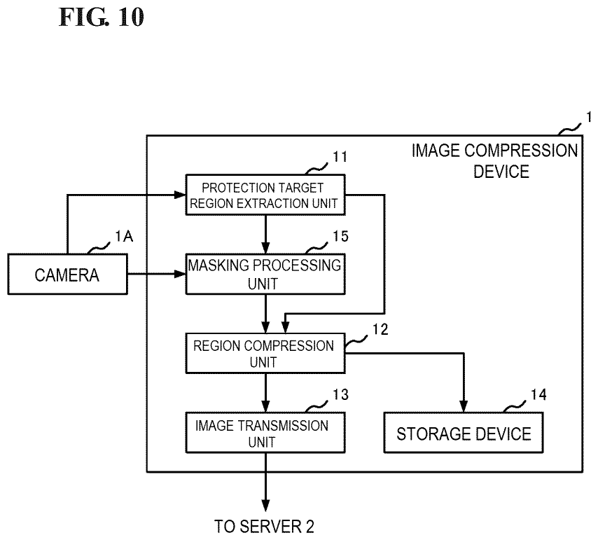

FIG. 10 is a block diagram showing an example of a configuration of image compression device 1 according to the second embodiment. Image compression device 1 is connected to camera 1A, and includes protection target region extraction unit 11, region compression unit 12, image transmission unit 13, storage device 14, and a masking processing unit 15.

Image compression device 1 may be configured by a computer system including a processor such as a CPU and storage device 14 such as a volatile memory or a non-volatile memory. Each of processing units 11, 12, 13, and 15 exerts its function by executing computer programs stored in storage device 14 on the processor.

The configuration of protection target region extraction unit 11 is the same as that of the first embodiment. However, protection target region extraction unit 11 outputs the result of extraction of the protection target region to masking processing unit 15 in addition to region compression unit 12.

Masking processing unit 15 receives the image captured by camera 1A from camera 1A. Masking processing unit 15 executes the masking process of removing the personal information from all the protection target regions in the image captured by camera 1A based on the result of extraction of the protection target region. The masking process includes a mosaic process of mosaicing the image, a blurring process of blurring the image, a smoothing process of smoothing the image, and the like. For example, masking processing unit 15 executes the masking process by performing at least one of the mosaic process, the blurring process, and the smoothing process on the block image included in the protection target region. Masking processing unit 15 outputs the image that has been subjected to the masking process to region compression unit 12.

Region compression unit 12 compresses the image that has been subjected to the masking process. Region compression unit 12 is the same as region compression unit 12 described in first embodiment except that the image to be compressed is the image that has been subjected to the masking process. The configurations of image transmission unit 13 and storage device 14 are the same as those in the first embodiment.

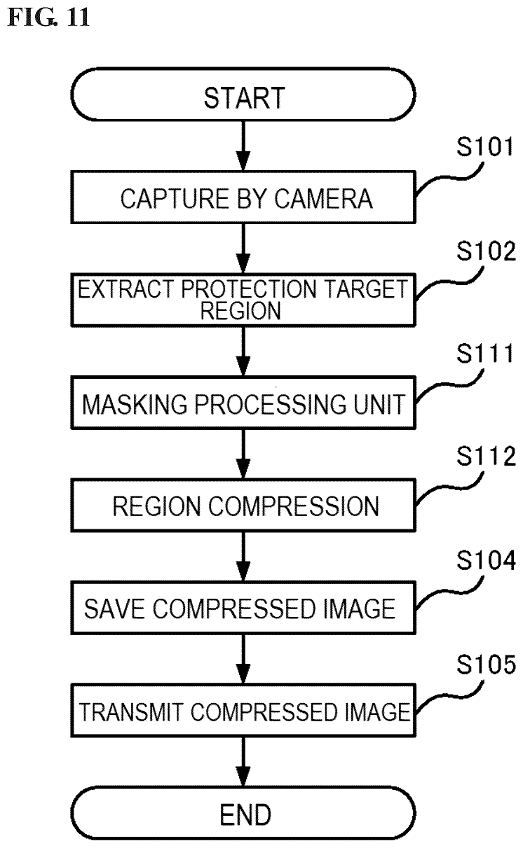

FIG. 11 is a flowchart showing an example of a procedure of processing executed by camera 1A and image compression device 1. Camera 1A executes the processing of step S101, and image compression device 1 executes the processing of step S102. The processing in steps S101 and S102 is the same as the processing in steps S101 and S102 described with reference to FIG. 8.

Masking processing unit 15 executes the masking process of removing the personal information from the protection target region in the image captured by camera 1A, based on the result of extraction of the protection target region (step S111).

Region compression unit 12 compresses the image that has been subjected to the masking process by compressing the protection target region extracted by protection target region extraction unit 11 at a compression ratio higher than a compression ratio for the region other than the protection target region in the image that has been subjected to the masking process (step S112).

Thereafter, image compression device 1 executes the processing of steps S104 and S105. The processing in steps S104 and S105 is the same as the processing in steps S104 and S105 described with reference to FIG. 8.

For example, when a size of the protection target such as a face or a license plate included in the protection target region in the image is large, there is a possibility that the personal information is read from the decompressed image, but by performing the masking process on the protection target region, the data amount of the image can be reduced while reliably removing the personal information.

### Third Embodiment

In the second embodiment, the masking process is always performed on all of the protection target regions, but it may be determined whether or not the masking process is performed on all of the protection target regions based on the size of the protection target. In the present disclosure, the size of the protection target does not mean the actual size of the protection target (actual size in the three dimensional space) but means the size in the image. For example, the size of the protection target means the number of pixels occupied by the protection target region in the image. The configurations of image processing system 100 and server 2 are the same as those in the first embodiment.

The configuration of image compression device 1 is the same as that of the second embodiment. However, as described below, a part of the configuration is different from that of the second embodiment.

Referring to FIG. 10, protection target region extraction unit 11 extracts the protection target region and the size of the protection target included in the protection target region from the image captured by camera 1A.

For example, protection target region extraction unit 11 divides the image into a plurality of blocks, and determines, for each block, whether or not a predetermined protection target is included, and when the protection target is included, whether the size of the protection target is large or small in the image.

The processing of protection target region extraction unit 11 will be described in detail below. The protection target to be determined by protection target region extraction unit 11 is, for example, a human face. However, the protection target is not limited to the human face, and may be a license plate of an automobile or the like.

Referring to FIG. 4, protection target region extraction unit 11 determines whether or not a human face is included in each of the blocks from block number 1 to block number 360, and when a human face is included, determines whether the size of the human face is large or small using a learning model. The learning model is, for example, a CNN, an RNN, or an AutoEncoder. Learning of human faces and the size of the human face in the image is advanced by a machine learning method such as deep learning using block images including various human faces as teacher data, and parameters of the learning model are determined. The size of the protection target (the size of a human face) is determined based on the area of the protection target and the area of the block in the image. Specifically, when the area of the protection target is larger than the area of the block, the size of the protection target is determined to be a large size, and when the area of the protection target is equal to or smaller than the area of the block, the size of the protection target is determined to be a small size.

Specifically, protection target region extraction unit 11 inputs the image including 360 block images to the learning model. The learning model determines whether or not the protection target is included in each block, and when the protection target is included, determines whether the size of the protection target is large or small, and outputs a determination result. Protection target region extraction unit 11 obtains the determination result from the learning model.

Referring to FIG. 5, protection target region extraction unit 11 extracts protection target regions 41A, 43A, 44A, and 45A from the image shown in FIG. 2. Protection target region extraction unit 11 determines that the sizes of the protection targets included in protection target regions 41A, 43A, and 45A are large, and determines that the size of the protection target included in protection target region 44A is small.

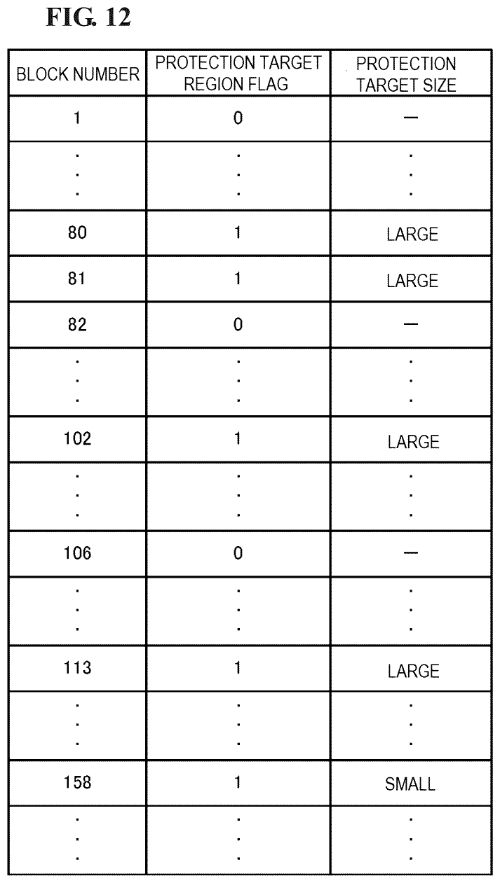

FIG. 12 is a diagram showing an example of a result of extraction of the protection target region and the protection target size by protection target region extraction unit 11. The table shown in FIG. 12 shows, for each block number, whether or not the protection target is included, and whether the size of the protection target is large or small when the protection target is included. That is, a block including the protection target is indicated by “1”, and a block not including the protection target is indicated by “0”. For example, it is indicated that the first block does not include the protection target. The 80th block (block included in protection target region 41A) includes the protection target, and the size of the protection target is shown to be large. The 158th block (block included in protection target region 44A) includes the protection target, and the size of the protection target is shown to be small.

Referring again to FIG. 10, protection target region extraction unit Il outputs the result of extraction of the protection target region and the protection target size to region compression unit 12 and masking processing unit 15.

Masking processing unit 15 refers to the result of extraction of the protection target region and the protection target size, and determines whether or not the protection target region including the protection target of large size exists in the image captured by camera 1A. For example, according to the result of extraction of the protection target region and the protection target size shown in FIG. 12, the protection target flag of the block number 80 is “1” and the protection target size is “large”. Thus, the protection target region including the protection target of the large size exists in the image.

When there is at least one protection target region including the protection target of the large size, masking processing unit 15 executes the masking process of removing personal information from all the protection target regions in the image captured by camera 1A.

Region compression unit 12 compresses the image that has been subjected to the masking process, as in the second embodiment. Region compression unit 12 adds position information of the protection target region in the image to the compressed image. An example of the position information is the result of extraction shown in FIG. 12.

Region compression unit 12 writes the compressed image to which the position information of the protection target region is added to storage device 14. Region compression unit 12 outputs the compressed image to which the position information of the protection target region is added to image transmission unit 13.

Image transmission unit 13 transmits the compressed image to which the position information of the protection target region is added acquired from region compression unit 12 to server 2 via network 3.

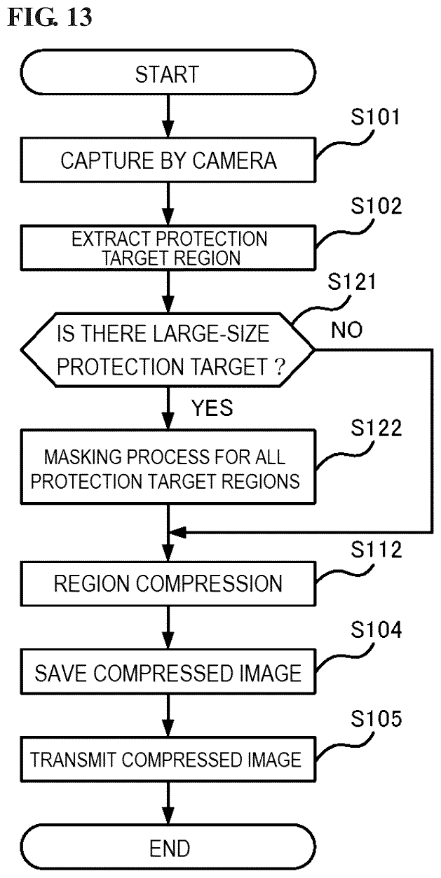

FIG. 13 is a flowchart showing an example of a procedure of processing executed by camera 1A and image compression device 1. Camera 1A executes the processing of step S101, and image compression device 1 executes the processing of step S102. The processing in steps S101 and S102 is the same as the processing in steps S101 and S102 described with reference to FIG. 8.

Masking processing unit 15 determines whether or not the protection target region including the protection target of large size is included in the image captured by camera 1A based on the result of extraction of the protection target region (step S121).

When the protection target region including the protection target of large size is included (YES in step S121), masking processing unit 15 executes the masking process of removing personal information for all the protection target regions in the image captured by camera 1A based on the result of extraction of the protection target region and the protection target size (step S122).

When the protection target region including the protection target of large size is not included (NO in step S121), the processing of step S122 is not executed.

Thereafter, image compression device 1 executes the processing of steps S112. S104, and S105. The processing in step S112 is the same as the processing in step S112 described with reference to FIG. 11. The processing in steps S104 and S105 is the same as the processing in steps S104 and S105 described with reference to FIG. 8.

According to the third embodiment, when the protection target region including the protection target, such as a face or a license plate, whose size is equal to or larger than a predetermined value, exists in the image, the masking process is executed for all the protection target regions, and in other cases, the masking process may not be executed. For example, the masking process is allowed to be executed when the area of the protection target is large compared to the area of the block, and the masking process is not allowed to be executed in other cases. This makes it possible to remove the personal information while preventing the masking process from being unnecessarily executed and reducing the data amount of the image.

### Fourth Embodiment

In the third embodiment, when the protection target region including the protection target of a large size exists in the image, the masking process is performed on all the protection target regions in the image. In contrast, in the fourth embodiment, the masking process is performed only on the protection target region including the protection target of the large size. The configurations of image processing system 100 and server 2 are the same as those in the first embodiment. The configuration of image compression device 1 is the same as that of the second embodiment. However, the configuration of masking processing unit 15 is partially different.

Referring to FIG. 10, masking processing unit 15 refers to the result of extraction of the protection target region and the protection target size acquired from protection target region extraction unit 11, and determines whether or not the protection target region including the protection target of the large size exists in the image captured by camera 1A. For example, according to the result of extraction of the protection target region and the protection target size shown in FIG. 12, the protection target flag of the block number 80 (the block included in protection target region 41A) is “1” and the protection target size is “large”. Therefore, the protection target region including the protection target of the large size exists in the image.

Masking processing unit 15 executes the masking process of removing the personal information from the protection target region including the protection target of the large size. Masking processing unit 15 does not execute the masking process on the other regions (the protection target regions including the protection targets of the small sizes and the regions other than the protection target regions).

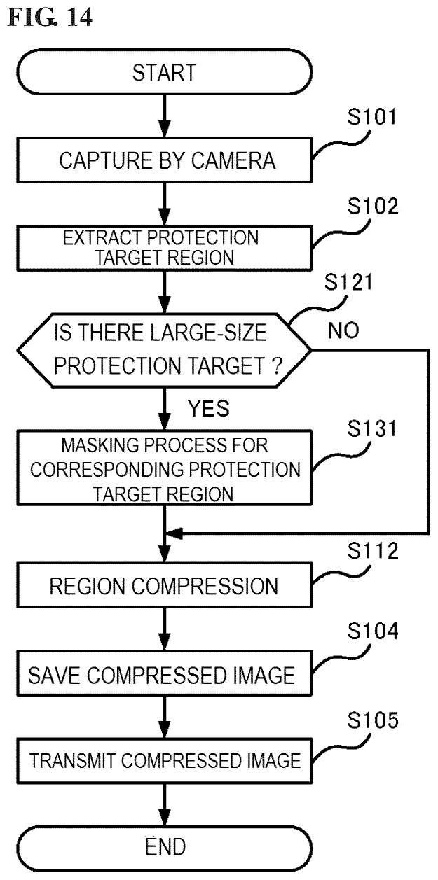

FIG. 14 is a flowchart showing an example of a procedure of processing executed by camera 1A and image compression device 1. Camera 1A executes the processing of step S101, and image compression device 1 executes the processing of step S102. The processing in steps S101 and S102 is the same as the processing in steps S101 and S102 described with reference to FIG. 8.

Masking processing unit 15 determines whether or not the protection target region including the protection target of the large size is included in the image captured by camera 1A based on the result of extraction of the protection target region (step S121).

When the protection target region including the protection target of the large size is included (YES in step S121), masking processing unit 15 executes the masking process of removing the personal information on the protection target region including the protection target of the large size (step S131).

When the protection target region including the protection target of the large size is not included (NO in step S121), the process of step S131 is not executed.

Thereafter, image compression device 1 executes the processing of steps S112. S104, and S105. The processing in step S112 is the same as the processing in step S112 described with reference to FIG. 11. The processing in steps S104 and S105 is the same as the processing in steps S104 and S105 described with reference to FIG. 8.

For example, when the size of the protection target such as a face or a license plate included in the protection target region is large, there is a possibility that the personal information is read from the decompressed image. In contrast, according to the fourth embodiment, the masking process is performed on the protection target region including the protection target of the large size, and thus the data amount of the image can be reduced while the personal information is reliably removed.

### Fifth Embodiment

In the second to fourth embodiments, image compression device 1 performs the masking process on the protection target region. In contrast, server 2 may perform the masking process on the protection target region.

The configurations of image processing system 100 and image compression device 1 are the same as those in the first embodiment. However, protection target region extraction unit 11 of image compression device 1 is the same as that shown in the third embodiment. That is, protection target region extraction unit 11 extracts the protection target region and the size of the protection target included in the protection target region from the image captured by camera 1A.

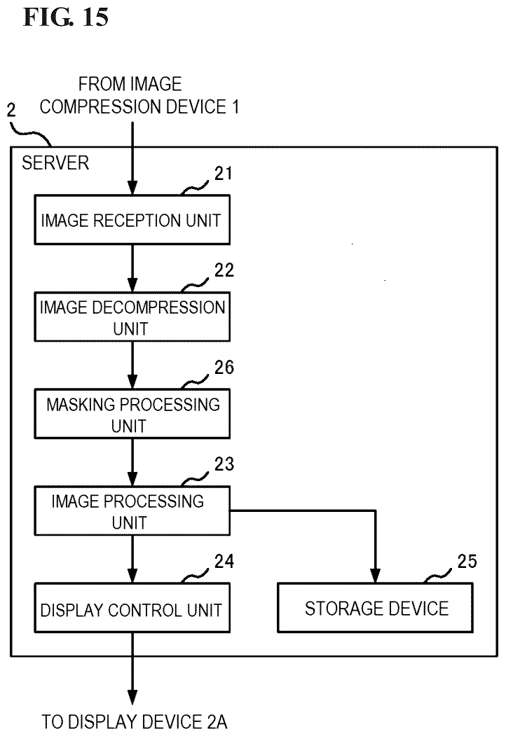

FIG. 15 is a block diagram showing an example of a configuration of server 2 according to the fifth embodiment. Server 2 includes image reception unit 21, image decompression unit 22, image processing unit 23, display control unit 24, storage device 25, and a masking processing unit 26.

Server 2 may be configured by a computer system including a processor such as a CPU and storage device 25 such as a volatile memory or a non-volatile memory. Each of processing units 21, 22, 23, 24, and 26 exerts its function by executing computer programs stored in storage device 25 on the processor.

Image reception unit 21 and image decompression unit 22 are the same as those in the first embodiment. However, image decompression unit 22 outputs the position information of the protection target region acquired from image reception unit 21 to masking processing unit 26.

Masking processing unit 26 performs the masking process on the protection target region including the protection target of large size in the decompressed image based on the position information of the protection target region. Masking processing unit 26 outputs the image that has been subjected to the masking process to image processing unit 23. An example of the masking process is as described in second embodiment. Ma·BR>X king processing unit 26 outputs the image that has been subjected to the masking process to image processing unit 23.

Image processing unit 23 performs the predetermined image processing on the image that has been subjected to the masking process. An example of the image processing is as described in first embodiment.

Image processing unit 23 outputs a result of the image processing to display control unit 24. Image processing unit 23 writes the result of the image processing in storage device 25. Display control unit 24 displays the result of the image processing acquired from image processing unit 23 on display device 2A.

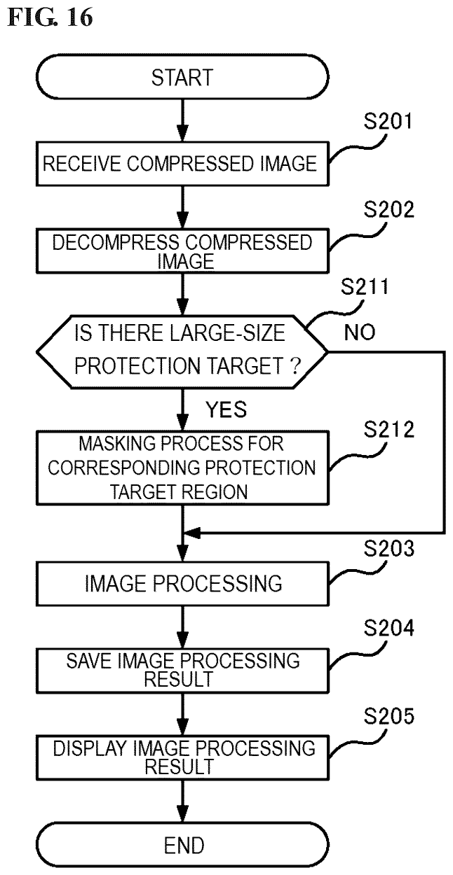

FIG. 16 is a flowchart showing an example of a procedure of processing executed by server 2. Image reception unit 21 receives the compressed image to which the position information of the protection target region is added from image compression device 1 via network 3 (step S201). An example of the position information is shown in FIG. 12.

Image decompression unit 22 decompresses the compressed image received by image reception unit 21 to restore the original image (step S202).

Masking processing unit 26 determines whether or not the protection target region including the protection target of the large size exists in the decompressed image based on the position information of the protection target region (step S211).

When the protection target region including the protection target of the large size is included (YES in step S211), masking processing unit 26 executes the masking process of removing the personal information on the protection target region including the protection target of the large size (step S212).

When the protection target region including the protection target of the large size is not included (NO in step S211), the process of step S212 is not executed.

Image processing unit 23 performs the predetermined image processing on the image that has been subjected to the masking process (step S203). Image processing unit 23 writes a result of the image processing in storage device 25 (step S204).

Display control unit 24 acquires the result of the image processing from image processing unit 23 and displays the result on display device 2A (step S205).

According to the fifth embodiment, server 2 that has acquired the compressed image and the position information of the protection target region can decompress the image while changing the compression ratio based on the position information. In addition, when the masking process is not performed, server 2 may perform the masking process on the protection target region based on the position information. Thus, server 2 can execute other image processing after reliably removing the personal information.

### Modification 1

In the third and fourth embodiments, the masking process is executed on the protection target region based on the size of the protection target included in the protection target region, but the compression ratio at the time of compressing the protection target region may be changed based on the size of the protection target included in the protection target region.

For example, image compression device 1 may set the compression ratio of the protection target region including the protection target of the large size to be larger than the compression ratio of the protection target region including the protection target of the small size. That is, the compression ratio is larger in an order of the compression ratio of the protection target region including the protection target of large size, the compression ratio of the protection target region including the protection target of small size, and the compression ratio of the other regions.

For example, the compression ratio can be increased as the size of the protection target such as a face or a license plate included in the protection target region is increased. This makes it possible to reduce the data amount of the image while reliably removing the personal information.

### Modification 2

In the first to fifth embodiments, protection target region extraction unit 11 of image compression device 1 extracts the protection target region in units of blocks, but the extraction method is not limited to this.

For example, protection target region extraction unit 11 may extract the protection target region by detecting the protection target from the image and dividing the protection target region from the other regions. Protection target region extraction unit 11 may detect the protection target from the image and extract the rectangle circumscribing the protection target as the protection target region.

### Appendix

Some or all of the constituent elements constituting each of the above-described devices may be constituted by one or more semiconductors such as system large scale integration (LSI).

The computer program may be recorded on computer-readable non-transitory recording media such as an HDD, a CD-ROM, and a semiconductor memory, and distributed. Further, the computer program may be distributed by being transmitted via an electric communication line, a wireless or wired telecommunication line, a network represented by the Internet, data-broadcasting, or the like. Further, each of the above-described devices may be achieved by a plurality of computers or a plurality of processors.

In addition, some or all of the functions of each of the above-described devices may be provided by cloud computing. That is, some or all of the functions of each device may be achieved by a cloud server. Furthermore, at least a part of the embodiments and the modifications may be arbitrarily combined.

The embodiments disclosed herein are to be considered in all respects as illustrative and not restrictive. The scope of the present disclosure is defined by the claims rather than the foregoing description, and is intended to include all modifications within the scope and meaning equivalent to the claims.

### REFERENCE SIGNS LIST

1 image compression device
1 A camera
2 server
2A display device
3 network
11 protection target region extraction unit (extraction unit)
12 region compression unit (compression unit)
13 image transmission unit (output unit)
14 storage device
15 masking processing unit
21 image reception unit
22 image decompression unit
23 image processing unit
24 display control unit
25 storage device
26 masking processing unit
41 person
41A protection target region
42 person
43 person
43A protection target region
44 person
44A protection target region
45 person
45A protection target region
100 image processing system

1. An image compression device comprising:
an extraction circuit configured to extract a protection target region from an image, the protection target region being a region including a protection target of personal information: and
a compression circuit configured to compress the image by compressing the protection target region at a compression ratio higher than a compression ratio for a region other than the protection target region in the image.

2. The image compression device according to claim 1, wherein the extraction circuit is configured to extract the protection target region by determining whether each of a plurality of blocks obtained by dividing the image corresponds to the protection target region.

3. The image compression device according to claim 1, further comprising a masking processing circuit configured to perform a masking process of removing the personal information from the protection target region, wherein
the compression circuit is configured to compress the image that has been subjected to the masking process.

4. The image compression device according to claim 3, wherein the masking processing circuit is configured to perform, based on a size of the protection target included in the protection target region, the masking process on the protection target region.

5. The image compression device according to claim 1, wherein the compression circuit is configured to determine, based on a size of the protection target included in the protection target region, a compression ratio at which the protection target region is to be compressed.

6. The image compression device according to claim 4, wherein the size of the protection target is determined based on an area of the protection target included in the protection target region and an area of each of blocks obtained by dividing the image.

7. The image compression device according to claim 1, further comprising an output circuit configured to output position information of the protection target region in the image.

8. An image compression method comprising:
extracting a protection target region from an image, the protection target region being a region including a protection target of personal information; and
compressing the image by compressing the protection target region at a compression ratio higher than a compression ratio for a region other than the protection target region in the image.

9. The image compression device according to claim 2, further comprising a masking processing circuit configured to perform a masking process of removing the personal information from the protection target region, wherein
the compression circuit is configured to compress the image that has been subjected to the masking process.

10. The image compression device according to claim 2, wherein the compression circuit is configured to determine, based on a size of the protection target included in the protection target region, a compression ratio at which the protection target region is to be compressed.

11. The image compression device according to claim 3, wherein the compression circuit is configured to determine, based on a size of the protection target included in the protection target region, a compression ratio at which the protection target region is to be compressed.

12. The image compression device according to claim 4, wherein the compression circuit is configured to determine, based on a size of the protection target included in the protection target region, a compression ratio at which the protection target region is to be compressed.

13. The image compression device according to claim 5, wherein the size of the protection target is determined based on an area of the protection target included in the protection target region and an area of each of blocks obtained by dividing the image.

14. The image compression device according to claim 2, further comprising an output circuit configured to output position information of the protection target region in the image.

15. The image compression device according to claim 3, further comprising an output circuit configured to output position information of the protection target region in the image.

16. The image compression device according to claim 4, further comprising an output circuit configured to output position information of the protection target region in the image.

17. The image compression device according to claim 5, further comprising an output circuit configured to output position information of the protection target region in the image.

18. The image compression device according to claim 6, further comprising an output circuit configured to output position information of the protection target region in the image.
